(19) United States
(12) Patent Application Publication
(10) Pub. No.: US 2006/0221297 A1
(43) Pub. Date: Oct. 5, 2006

(54) Eyeglass temple unit

(76) Inventor: Chiang-Tung Tsai, Tainan Hsien (TW)

Correspondence Address: PEARL COHEN ZEDEK, LLP, 1500 BROADWAY 12TH FLOOR, NEW YORK, NY, 10036, US

(21) Appl. No.: 11/097,148

(22) Filed: Apr. 4, 2005

(51) Int. Cl. G02C 5/00

(52) U.S. Cl. 351/41

(57) ABSTRACT

An eyeglass temple unit includes a connecting piece and a temple piece. The connecting piece is adapted to be connected to a lens unit, and is formed with a hole defined by a hole-defining wall. The hole-defining wall is formed with a plurality of first teeth. The temple piece is formed with a stud which extends into the hole so as to be pivotable about an axis defined by the stud, and which is formed with a plurality of second teeth. The second teeth engage the first teeth so as to permit positioning of the temple piece on the connecting piece at a desired angular position relative to the axis.

### BACKGROUND OF THE INVENTION

1. Field of the Invention

The invention relates to an eyeglass temple unit, more particularly to an eyeglass temple unit that has a temple piece capable of being positioned on a connecting piece at a desired angular position.

2. Description of the Related Art

In the design of a pair of eyeglasses, the temple unit thereof must be adjustable to suit different contours of cheeks and noses of different wearers.

At present, there are various types of designs for this sort of adjustment. Yet, under the premise of providing basic adjustment function and lower cost, simplicity of structure and convenience of assembly are always the issues of greater concern.

### SUMMARY OF THE INVENTION

Therefore, the main object of the present invention is to provide an eyeglass temple unit that has a simple structure and that is convenient to assemble.

Accordingly, an eyeglass temple unit of the present invention comprises a connecting piece and a temple piece.

The connecting piece is adapted to be connected to a lens unit, and is formed with a hole defined by a hole-defining wall. The hole-defining wall is formed with a plurality of first teeth.

The temple piece is formed with a stud which extends into the hole so as to be pivotable about an axis defined by the stud, and which is formed with a plurality of second teeth. The second teeth engage the first teeth so as to permit positioning of the temple piece on the connecting piece at a desired angular position relative to the axis.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary exploded perspective view of the preferred embodiment of an eyeglass temple unit according to the present invention;

FIG. 2 is a fragmentary partly sectional view of the preferred embodiment in a disassembled state; and

FIG. 3 is a fragmentary partly sectional view of the preferred embodiment in an assembled state.

### DETAILED DESCRIPTION OF THE PREFERRED EMBODIMENT

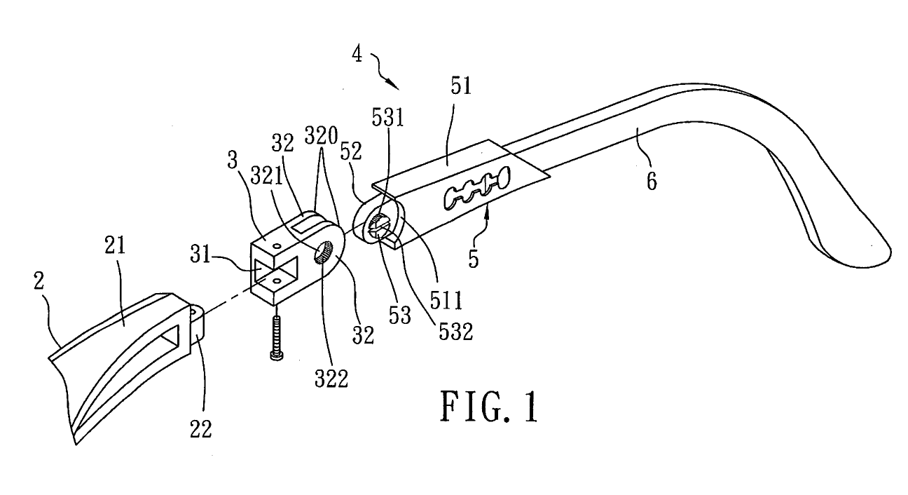

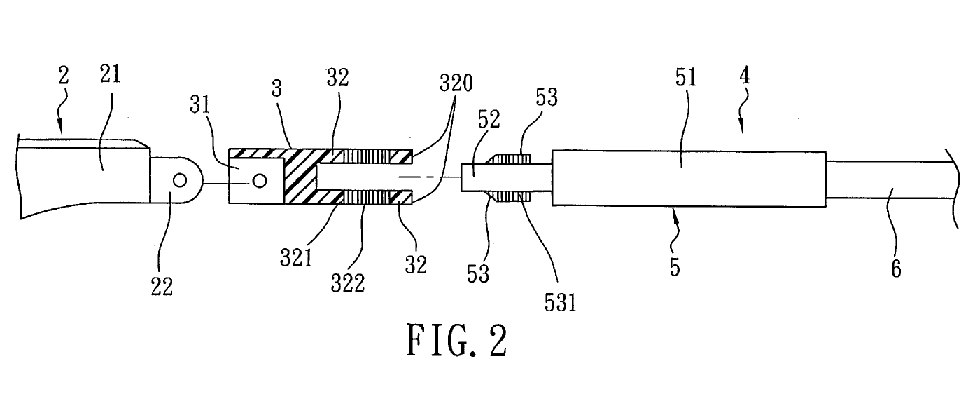

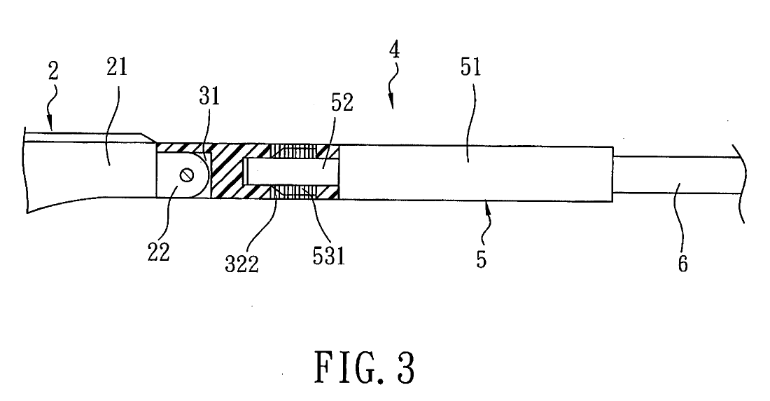

Referring to FIGS. 1, 2 and 3, the preferred embodiment of an eyeglass temple unit according to the present invention is shown to comprise a connecting piece 3 and a temple piece 4. The connecting piece 3 is connected to a lens unit 2.

The lens unit 2 has a connecting end portion 21 formed with a pivot lug 22. The connecting end portion 21 of the lens unit 2 can be a portion of a frame or a portion of a lens.

The connecting piece 3 includes a front portion 31 formed with a groove for receiving and hinging the pivot lug 22 to permit pivoting about a pivot axis of the pivot lug 22, and a bifurcated rear portion 32 that is opposite to the front portion 31 and that has two opposite arms cooperatively defining a recess therebetween. Each of the arms is formed with a hole 321 defined by a hole-defining wall. The hole-defining wall is formed with a plurality of first teeth 322.

The temple piece 4 has a first part 5 and a second part 6. The first part 5 of the temple piece 4 has a front end 51 that is formed with a protrusion 52 extending into the recess between the arms of the bifurcated rear portion 32. The protrusion 52 has a pair of lateral sides, each of which is formed with a stud 53 which extends into a corresponding one of the holes 321 in the arms of the bifurcated rear portion 32 so as to be pivotable about an axis defined by the stud 53, and which has a surrounding wall formed with a plurality of second teeth 531. The second teeth 531 engage the first teeth 322 so as to permit positioning of the temple piece 4 on the connecting piece 3 at a desired angular position relative to the stud axis. The stud 53 is cylindrical in shape, has a tapering end face, and is formed with a groove 532 that cuts the stud 53 into two stud halves so as to impart pliability to the stud halves and so as to facilitate rotation of the temple piece 4 about the stud axis.

In this embodiment, the front end 51 of the first part 5 of the temple piece 4 has a concave end face 511, and the arms of the bifurcated rear portion 32 of the connecting piece 3 respectively have convex rear end faces 320 that conform to and that are in sliding contact with the concave end face 511.

In assembly, the protrusion 52 at the front end 51 of the first part 5 of the temple piece 4 is pushed into the recess between the arms of the bifurcated rear portion 32 to permit the studs 53 to extend into the corresponding holes 321 in the arms of the bifurcated rear portion 32 of the connecting piece 3. At this time, the concave end face 511 of the first part 5 of the temple piece 4 abuts rotatably against the convex rear end faces 320 of the connecting piece 3 to enhance positioning of the first and second teeth 322, 531. It is evident that the aforesaid assembly process is quick and convenient.

After assembly, the second teeth 531 are operable to engage the first teeth 322 so as to permit positioning of the temple piece 4 on the connecting piece 3 at a desired angular position relative to the stud axis. During rotation of the temple piece 4, the stud halves of the stud 53 can be slightly and elastically deformed so as to facilitate the rotation.

The second part 6 of the temple piece 4 is telescopically connected to the first parts of the temple piece 4. Since the mechanism for adjusting the relative positions of the first and second parts 5, 6 is not the main point of this invention, it will not be detailed further herein for the sake of brevity.

It is worth to note that, in practice, only one of the arms of the bifurcated rear portion 32 may be formed with the hole 321, and only one of the studs 53 may be formed on the protrusion 52 at the front end 51 of the first part 5 of the temple piece 4 to provide the required positioning effect.

In sum, in this invention, with the inclusion of the second teeth 531 on the surrounding wall of the stud 53 of the temple piece 4 and the first teeth 322 on the hole-defining wall of the hole 321 in the bifurcated rear portion 32 of the connecting piece 3 in the eyeglass temple unit of this invention, the temple piece 4 and the connecting piece 3 can be easily assembled together, and the temple piece 4 can be easily adjusted to a desired angular position relative to the lens unit 2.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An eyeglass temple unit comprising:
a connecting piece that is adapted to be connected to a lens unit and that is formed with a hole defined by a hole-defining wall, said hole-defining wall being formed with a plurality of first teeth; and
a temple piece that is formed with a stud which extends into said hole so as to be pivotable about an axis defined by said stud, and which is formed with a plurality of second teeth, said second teeth engaging said first teeth so as to permit positioning of said temple piece on said connecting piece at a desired angular position relative to said axis.

2. The eyeglass temple unit as claimed in claim 1, wherein said connecting piece has a bifurcated rear portion that has two opposite arms which cooperatively define a recess therebetween, said hole in said connecting piece being formed in at least one of said arms, said temple piece having a first part that has a front end which is formed with a protrusion extending into said recess between said arms, said stud protruding from said protrusion.

3. The eyeglass temple unit as claimed in claim 2, wherein said front end of said first part has a concave end face, said arms respectively having convex rear end faces that conform to and that are in sliding contact with said concave end face.

4. The eyeglass temple unit as claimed in claim 1, wherein said stud is cylindrical in shape, and is formed with a groove that cuts said stud into two stud halves so as to impart pliability to said stud halves and so as to facilitate rotation of said temple piece about said axis.
